(19) United States
(12) Patent Application Publication
(10) Pub. No.: US 2009/0177576 A1
(43) Pub. Date: Jul. 9, 2009

(54) AUTOMATED LOAN PLACEMENT SYSTEM

(76) Inventor: Joe CUGLIARI, North Huntingdon, PA (US)

Correspondence Address: NILS H. LJUNGMAN & ASSOCIATES, P. O. BOX 130, GREENSBURG, PA, 15601-0130, US

(21) Appl. No.: 12/346,294

(22) Filed: Dec. 30, 2008

Related U.S. Application Data
(60) Provisional application No. 61/018,385, filed on Dec. 31, 2007.

(51) Int. Cl. G06Q 40/00

(52) U.S. Cl. 705/38

(57) ABSTRACT

An automated loan placement system. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### BACKGROUND

1. Technical Field

The present application relates to an automated loan placement system.

2. Background Information

Background information is for informational purposes only and does not necessarily admit that subsequently mentioned information and publications are prior art.

In lending, there are loan consultants, such as the people that concentrate in prospecting, or finding opportunities for a mortgage loan. Upon finding such opportunity, which is now called a “lead,” the “lead” is forwarded to a loan officer. The loan officer adds value to this “lead” by confirming and validating the information received through the borrower's provided documents and also providing a written set of mortgage loan terms to the borrower.

It is at this point that a sale either occurs or it does not occur, which is based on the borrower's decision. This decision can be based on a number of factors or on combinations of factors depending upon the individual borrowers. Such factors can include, among others: mortgage loan terms, the timeframe of the transaction, timeliness of information, degree of service, credibility of the seller, relationship with the seller, etc.

When a sale occurs, it is validated with the order of an appraisal which the borrower agreed to have conducted and pay directly to the appraiser at the time of the visit to the property. After this validation, the mortgage company proceeds to begin processing the loan, or in essence building a file for an underwriter to evaluate. Then, the mortgage company either approves or does not approve a loan, and title insurance on the property is ordered at this point.

There is a disconnect in this industry between the sales people and the technical people, and yet they have to work together. The degree to which they work together determines how efficient their operation becomes.

Sales people tend to generalize, and for the most part they are not detail-oriented. They tend not to concentrate on the factors that can stop a transaction but rather on the factors that can advance it. They do not like long questionnaires. Technical people are mostly the opposite; they tend to be somewhat specific, detail-oriented, and they tend to concentrate in overcoming potential pitfalls, and do spend the time to answering long questionnaires.

These differing attitudes create the disconnect which interferes with the process of trying to market, prospect, sell, process, and close a loan. There are many different types of people that need to collect information and interact with one another, each speaking their own languages. This causes, in many instances, service to suffer (the old garbage in garbage out syndrome). The borrower does becomes the victim to the results at times.

Here is a typical example of a disconnect that makes the borrower the victim:

The loan officer obtains information from a potential borrower that the borrower does not qualify for the loan program that the loan officer originally promoted. The loan consultant did not have the tools to make a solid determination and based on those tools, the loan consultant proceeded.

Then, the loan officer attempts to qualify and present an alternative to the loan program which the loan officer originally promoted. The loan officer calls several lenders and tells these lenders about the credit score, value of the property, the loan to value desired by the borrower, etc. The lenders respond that they will look into it and call the loan officer back. The loan officer then should get back to the potential borrower, but these lenders are not responding in a timely manner. Nevertheless, one lender gets back to the loan officer, recommending a certain loan program. The loan officer calculates the benefits the potential borrower will receive based on the provided terms, and right away calls the prospect and present these new findings. The loan officer proceeds to explain the new benefits that will be realized with the new loan and the reason for the change in loan programs. At this point, the loan officer feels that some points were lost due to being unable to get back to the prospect with a prompt response, and when the loan officer did, there was a change in the benefits of the loan; however, the loan process is progressing. The prospect gives the okay to submit the loan to processing, to schedule the appraisal, and to forward documents.

The loan processor calls the loan officer to say that this loan program is not for this prospect's situation and the prospect will not qualify.

The loan officer proceeds to tell the processor that it is okay to proceed because the loan officer checked with the lender representative, who said it was fine. The loan gets submitted to underwriting, and it comes back approved with a lower loan to value or a substantially higher interest rate that severely cuts into the benefits, or better yet the loan is denied!

The loan officer first calls the lender representative to tell the lender representative that the loan has not been approved according to the terms that were originally described, and that the customer or borrower is looking for those terms. The lender representative replies, “Let me look into it.” He calls the loan officer back and explains that the reason why the loan terms changed. The loan officer says, “Well, you did not tell me that!” And the lender representative says, “You did not ask!”

Now the loan officer has a problem.

The loan officer should either call the borrower back and present a third change, and hopefully the prospect will continue with the loan process and still be able to give the loan officer referrals, or give up most of the loan officer's fees because the loan officer does not want to make that third presentation and run the risk of losing the loan.

Also included in the spectrum of lending are a lot of mortgage loan search engines. Many mortgage companies have them, and there are a lot of pricing engines.

Some drawbacks of mortgage loan search engines include that the search engines are very technical and long-winded, and one has to or should know lending in order to operate them. Generally speaking, most people that know lending give up using mortgage loan search engines because these people have to go through a lengthy, time-consuming process because of the amount of questions the system asks. Even after obtaining a result, that result still may be flawed because most systems do not account for some factors, for example credit trade lines, collections, etc., and for estimated closing costs from lending and third parties.

One mortgage pricing engines drawback is that mortgage loan search engines do not qualify or pre-qualify the borrower. The search engines help the borrower to find the lenders that are capable of doing a loan given a certain credit score and a certain documentation type. Mortgage loan search engines do not get into how the income is interpreted or how the credit score is interpreted. These engines do identify lenders and provide best to worst pricing.

In banking we have found that control is always being strived for in operations, that explains the systems that are out there technical and made for use only for technical operational people.

In other words, there are two existing systems for determining loan programs available to a potential borrower. The first involves filling out unnecessarily long, detailed questionnaires with technical questions, which provide generally accurate results and pre-qualification for a loan. Such questionnaires are redundant, frustrating, and discouraging to borrowers unfamiliar with lending practices. These drawbacks turn off potential users because of the undesirability involved with the questionnaires. The other, second system for determining loan programs available to potential borrowers involves mortgage loan search engines. The borrower does not need to be familiar with lending to use the system. These search engines involve answering few questions; however, due to the simplicity and baseness of the questions asked, an accurate result is not produced. Instead, the borrower is provided a list of loan programs for which the borrower could potentially qualify. The list generated by the search engines does not identify which program could prove to be most beneficial to the borrower. The mortgage loan search engines do not pre-qualify the potential borrower for a loan.

### OBJECT OR OBJECTS

The present application attempts to eliminate, restrict, and/or minimize this disconnect, by providing to the loan consultants what is necessary or desired for them in the easiest way, in their “language” so that the system is easy to use and they can prosper by using it, while also providing to the loan officers the resources and ability to perform their work in their “language,” so that the flow of information transfers from a loan consultant to a loan officer to a processor without interference.

A further object of this system is to provide representatives with a way of pre-qualifying a potential prospect's financial situation instantly without relying on a lender representative. The automated loan placement system of the present application makes it possible to have a timely reliable pre-qualification right upfront that will prevent “garbage in garbage out.” Loan officers and/or loan consultants no longer need to worry about their ability to get back to the borrower on a timely manner or having to make a third re-sale!

### SUMMARY

The present application is a web-based software with several modules.

Pre-qualification module comprises input, output, and recommendations.

Submission module comprises accepting data and automated form completions.

The process is easy and simple. Information is entered and a loan program is selected, and output is provided and recommendations are given. Upon acceptance, information is sent to a submission system that automatically completes necessary forms. This system makes the process from marketing to sales to closing process. This system could also be used to generate leads by advertising a website with universal passwords. Members of the public would use the universal passwords to generate their own private passwords and then they will be able to generate their own qualifications in real time. The information can be collected on the back end by the person that is running the campaign.

The present application provides real-time information to people that need it to perform their jobs better. The system allows a builder, attorney, etc, to qualify their customer in real time for a loan transaction and use the information to proceed with their work.

This system will allow the consultant to enter a prospect's information in a concise manner and instantly identify and talk about potential pitfalls right upfront with the prospect. Each party knows what they are in for, no false expectations are created, and there is minimal potential for miscommunication. The loan officer can confirm and validate much quicker and generate written mortgage loan terms much faster and more accurately. The processor will be working with valid information and the opportunity of spending time on garbage information is greatly reduced, eliminated, restricted, and/or minimized.

This system allows the borrower to input information directly into the system and also to be able to generate a pre-qualification letter in real time, these are people found by loan consultants. The loan consultant does not have to ask the questions anymore; the system of the present application does it for them. The loan consultant can instead concentrate on prospecting. The loan officer receives the information that was inputted by the borrower, confirms/validates the information, and issues automated mortgage loan terms. These loan terms need to be approved by the borrower before the processor begins with the processor's part, assuring them that they are working with solid opportunities.

The system of the present application provides the ultimate control for a lending operation, not in operations but in marketing and sales, so that it prevents, restricts, and/or minimizes “garbage in garbage out” and makes both the system and service to the customer more efficient. In one possible embodiment, this system can be given to real estate agents to use, for them to obtain enough information out of the system such as a pre-qualification, loan terms, and estimated closing costs to handle objections and capture the sale. On the back end, the loan officer works on validating and confirming the loan, which are two different objectives. This system can be given to home builders, financial planners, lawyers, benefit departments of companies, banks/credit unions (as alternative programs), for sale by owner, organizations, etc., in further embodiments. In at least one possible embodiment according to the present application, this system can be promoted on the internet with search engines such as Google, Yahoo, etc., and will provide the results of a pre-qualification, estimated closing costs from lending, title and government in real time. Additionally, a potential borrower can generate a private account which will allow the borrower to use it in an on-going manner.

The following definitions are provided, however, to avoid any ambiguity. “Mortgage” refers to financing secured by real property. It refers to both first and second mortgages, home equity loans, and home equity lines of credit.

“Mortgage loan program” refers to a mortgage offering of a particular financial institution. A “mortgage loan program” is distinguished from other mortgage loan programs by a unique combination of at least the following features: (a) the financial institution; (b) the type of mortgage (first, second, etc.); (c) the purpose of the mortgage loan (purchase, refinance, refinance with cash out etc.); (d) the type and term of the loan (for example, 30 year fixed, 15-year fixed, and adjustable rate mortgages with various terms); (e) the minimum credit characteristics required to qualify for the mortgage loan program; and (f) the location of the real property. Each distinct mortgage loan program will differ from other mortgage loan programs in at least one of these characteristics, and each distinct mortgage loan program carries with it an associated interest rate and other terms, which will vary as a function of market conditions.

“Closing costs” refer to fees paid at closing to complete the loan transaction, whether paid in cash or financed as part of a mortgage amount. Such closing costs include all lender fees (such as buy down points and fees for processing, document preparation fees, underwriting fees, credit report fees, tax service, wire transfer fees, flood certification, reconveyance and notary service) and third party fees paid by the borrower (such as appraisal fees, title insurance premiums and loan escrow fees (in the case of refinance transactions)).

In other words and in accordance with at least one possible embodiment of the present application, the automated loan placement system strives to produce a third system for determining loan programs available to a potential borrower, which is both as simple and accurate as possible. n one possible embodiment, the automated loan placement system is borrower-based, which can eliminate, restrict, or minimize the role of a loan consultant in the borrowing process.

The above-discussed embodiments of the present invention will be described further herein below. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

The present application is described in greater detail with reference to the accompanying figures, in which:

FIG. 1 shows a diagram of the automated loan placement system as used by the borrower;

FIG. 2 is a block diagram flowchart showing the use of one possible component of the present application through a website by a borrower;

FIG. 3 is a block diagram flowchart showing the use of one possible component of the present application through a website by a loan officer or loan consultant;

FIG. 4 shows a schematic representation of an embodiment of a possible component of the present application;

FIG. 5 shows in greater detail a flow chart of the process done by the second computer 3 in an embodiment of a component of the present application;

FIG. 6 shows a detail view of the credit history report collection process (201);

FIG. 7 shows the process (101) of generating loan filtering parameters in greater detail;

FIG. 8 shows the process (400, 401) of generating actual loan costs in greater detail;

FIG. 9 shows the process (500, 501) of obtaining pricing adjustments in greater detail;

FIGS. 10-24 show various pages of a web-based data and information collection system which may be used in the method of the present application;

FIG. 10 shows the opening page of the web-based data and information collection system;

FIG. 11 shows a screen in which a choice is offered between a conventional quick search and a custom search in accordance with a possible component of the present application;

FIG. 12 shows the next page of the web system in which basic customer information is collected;

FIG. 13 shows the next page of the web system in which basic customer information is collected, and it also has entry fields for the creation of a user ID for immediate log in on subsequent visits;

FIG. 14 is displayed showing that the evaluation is in progress once the user inputs the information requested on the pages shown in FIGS. 12 and 13 and indicates that he or she wants to proceed with the custom rate search;

FIG. 15 shows the next screen which gives a list of available loan programs is displayed;

FIG. 16 shows the screen that results from clicking the link in FIG. 15 in the “Type” or “Product” column displays a screen. This screen provides an explanation of the particular loan product to the consumer;

FIG. 17 shows the screen that results from clicking the “View More” link in FIG. 15 in the “Available Rate Options” column. This screen provides rate and point options within the loan program, and provides an option to “apply now” and an option to print a pre-approval certificate;

FIG. 18 shows a pre-approval certificate;

FIG. 19 shows the screen that results if the consumer selects “apply now” on the screen shown in FIG. 17. This screen confirms that the user's application is complete and provides contact information regarding the loan specialist assigned to the application;

FIG. 20 shows an example of the response provided to the consumer if the user inputs the information requested on the pages shown in FIGS. 12 and 13 and no loan programs are available based on such information;

FIG. 21 shows an example of the page displayed to the user that has already conducted a custom rate search in a previous session and has returned to the website and accessed the log on feature shown in FIG. 10;

FIG. 22 is displayed once the consumer enters their log on information. This screen displays all of the custom rate searches performed by the consumer;

FIG. 23 shows the screen that results from clicking the link in FIG. 22 in the “Rates” column. This screen is similar to the screen displayed to the consumer when they first performed the custom rate search (FIG. 15), however, there is one additional function-a button that invites the user to “Update Rates;” and

FIG. 24 shows the screen that results from clicking the link titled “Modify your search” on the screens shown in FIG. 15 and FIG. 23, which allows the user to modify the information used by the system in performing the custom rate search.

### DESCRIPTION OF EMBODIMENT OR EMBODIMENTS

The present application is the development of a common language/system across all residential/commercial lending. Common language is structured in sectors: Loan Family, Loan Product, and Loan Program.

(1) A Loan Family pertains to a unique characteristic that is prominent in the lending marketplace. For example, the loan family may have the ability to have up to four different configured monthly payments that come with these programs. Another family may have up to two or less monthly payments, or it can be a specialized area. The specialized areas could be construction loans or government-backed loans. They can also be based on type of credit or property such as condo-tells and borrower type like a foreign national. These factors are examples of what differentiates a loan family.

(2) Loan Product pertains to a given investor/lender that has a product in a defined Family.

(3) Loan Programs provide a selection of terms for the borrower that exists within a loan product. For example having to choose from a 3/1, 5/1, 7/1, or 10/1 ARM (Adjustable Rate Mortgage). If the 3/1 ARM is selected, the rate would be fixed for three years, then adjusts every year; if the 5/1 is selected, the rate would be fixed for five years and then adjusts every year after, and continues with the 7/1 and 10/1 ARM selections.

With the three sectors, we then have inputted most programs into our system from various lenders, and we are then able to have a common output (pre-qualification) for the borrower.

The web-based pre-qualification system according to the present application accounts for credit situations and provides estimated costs from lending, title insurance, government, and other third parties. This information is provided in real time. A borrower will receive loan terms and estimated closing costs all in real time with the ability to generate it themselves. In at least one possible embodiment according to the present application, the pre-qualification system can actually provide potential borrowers with an account that they can go to and run their situation anytime they would like. The potential borrowers can use it like a calculator to determined what they need to do or where they need to get to from a standpoint of credit, income, or some other factors in order to be able to obtain the loan program they would ultimately want. Another example would be utilizing the system to analyze the borrowers' situation to see how much cash out they can obtain a from a refinance transaction on their existing house and how much money down they would need to purchase a new home that they saw. The borrower would be able to perform all these analyses, including loan terms and estimated closing costs, without having to talk to one single mortgage representative!

In one possible embodiment according to the present application, in individual monitors changes made to loan programs, for example rate changes, guidelines, etc., and updates the pre-qualification system so that users get the best of both lending systems, the accuracy of pre-qualification questionnaires and the simplicity of mortgage loan search engines.

The mortgage company selects the loan programs and also selects pricing options that will be made available in the system. This information, along with interest rates, guideline information, third party fees such as title and government, are maintained in the system on a regular basis to keep up with real-time changes made by mortgage companies and other lenders. This capacity allows the mortgage company to control the loan programs that are being promoted to certain audiences. Maintenance of these changes is performed to provide information as accurate as possible

This system asks the borrower or user a couple of simple questions upfront. Then, based on those answers, the user needs to select a loan product from a list provided (based on the answers provided, the available list of loan products is generated). Upon selecting a loan product, a specific set of questions is selected by the system to ask the user. These two processes eliminate a substantial amount of questions and redundancy. Upon answering questions about a borrower's address, employment, assets, credit and liabilities, property information and transaction information, the system will provide a pre-qualification letter that can be printed or e-mailed. The system is set up for the borrower to use the system directly. However, in another possible embodiment, a third party such as a real estate agent, home builder, financial planner, among others, may facilitate the process.

The system is strategic enough that, based on the way certain answers are answered, the system configures closing costs according to those answers. Some factors which influence the selection of the loan program include how long the borrower is planning to hold that mortgage, what type of closing costs are being preferred in terms of timeframe, etc.

In one possible embodiment of the system according to the present application, this system also provides the reason for not qualifying the borrower and what the borrower should overcome in order to obtain the desired loan. It is in writing for the borrower to see. In another possible embodiment, there may be other options, such as loans with less attractive terms or overcoming factors in order to qualify choose your alternative.

In other words and in accordance with at least one possible embodiment of the present application, a potential borrower begins the borrowing process by using the system of the present application. The borrower or user logs into the system and answers a first series of questions. Once the first series of questions is answered, a response comprising a loan product or several loan products are generated by the automated loan placement system. The feedback generated by the automated loan placement system depends on the answers given to the first series of questions.

Next, the borrower or user then selects a loan product from the response generated by the automated loan placement system. Once a loan product is selected, another, second series of questions is generated. The answers given by the borrower to this second series of questions determines whether the borrower pre-qualifies for the selected loan product. If the borrower qualifies for the selected loan product, a pre-qualification letter is generated, which can either be e-mail or printed. Also, the real-time closing costs for the loan product is generated by the automated loan placement system. The borrower can then take this information to the bank offering the loan product to continue the borrowing process. If the borrower does not pre-qualify for the loan product, the automated loan placement system provides the reason why the borrower did not pre-qualify. In one possible embodiment, the automated loan placement system can generate another loan product instead, or offer instructions on how to remedy the situation and pre-qualify for the originally selected loan product.

The automated loan placement system is maintained and updated as changes to the offered loan products and loan programs are made by the mortgage company or bank.

In one possible embodiment according to the present application, the automated loan placement system is used by a loan officer or loan processor use in a bank. The system would then be programmed with the loan products offered by that bank. A mortgage company could also use the automated loan placement system in a similar way.

In another possible embodiment, the automated loan placement system is used by a third party lender, who would compile loan programs offered by several banks and/or mortgage companies. The automated loan placement system, used in this way, could comprise tens, hundreds, or even thousands of loan products.

In yet another possible embodiment of the present application, the automated loan placement system could be configured to be a website run by possible a bank or mortgage company loan officer, bank or mortgage company loan processor, or third party lender. In this embodiment, is possible to sell a membership to potential borrowers, so the borrower can then begin the borrowing process by inputting data and answering questions.

In other words, the first step of the automated loan placement system of the present application is for the borrower to input a variety of factors into the system during the first round of questions. While the factors, and therefore the questions, are determined by the person or group running the system, some examples of inputted factors may include: middle credit score of the borrower, middle credit score of the co-borrower, program family, document type, purpose of loan, occupancy, property type, state where the property is located, and whether or not all borrowers will be occupying the property. After each of these factors are inputted, a loan product or several loan products are generated by the automated loan placement system. The loan products generated by the automated loan placement system are loan products for which the borrower or user may pre-qualify. The user or borrower then selects a loan product from the generated list, and continues the process.

Once a loan product is selected, the automated loan placement system generates a second round of questions. The questions in this second round are determined by the loan product selected, and the questions are designed to gather relevant information which the borrower and the loan officer may need or may use to make a final decision regarding the loan product. Since the second round of questions is dependent on the selected loan product, the questions differ among the loan products. Some examples of second-round questions may include questions about the borrower's/co-borrower's names, the borrower's/co-borrower's home telephone numbers, work telephone numbers, and mobile telephone numbers, the borrower's/co-borrower's e-mail address or e-mail addresses, the borrower's/co-borrower's current address or addresses, how long the borrower/co-borrower's has lived at the borrower's/co-borrower's current address or addresses, type of ownership of the borrower/co-borrower at the borrower's/co-borrower's current address or addresses, the borrower's/co-borrower's employment types, the borrower's/co-borrower's self-employment histories, the borrower's/co-borrower's salaried employment histories, the name of the borrower's/co-borrower's current employers, the borrower's/co-borrower's positions with their respective current employers, the amount of years the borrower/co-borrower has spent with their respective current employers, the number of years the borrower/co-borrower has spent in that position, the borrower's/co-borrower's gross monthly incomes, the borrower's/co-borrower's liquid assets, the borrower's/co-borrower's current monthly housing expenses, the borrower's/co-borrower's mortgage/rent histories, the borrower's/co-borrower's number of years of credit history, the number of open trade lines reporting for, if all Judgments, Collections and Charge Offs over $5000 aggregate have been paid, any bankruptcy filing date, any bankruptcy discharge date, any foreclosure completed date, the borrower's/co-borrower's total monthly consumer debt payments excluding all housing payments, the borrower's/co-borrower's citizenship statuses, the total number of current mortgages, residential and commercial, the total number of current residential mortgages on 1-4 unit properties, if the subject property is the same as the borrower's/co-borrower's current address, the subject property address, the subject property zoning, how long the borrowers/co-borrower has owned the subject property, when the subject property was last listed for sale, the monthly condo fees, annual property taxes and insurance premiums, the loan program, the goal, the fair market value, the cash out, if the borrower/co-borrower wishes to include taxes and insurance in the monthly payment, the first mortgage balance, the second mortgage balance, the first installment loan balance, the second installment loan balance, the first revolving credit balance, the second revolving credit balance, the other loan balance, the shortage from new first, the existing total mortgage payment, the existing mortgage payment to principal, the existing mortgage payment to interest, the length of time the borrower/co-borrower has had the existing mortgage, the expected mortgage duration, the estimated closing date, the type of closing costs preferred, and a prepayment penalty option, among others.

After the borrower or user inputs the desired data for this second round of questions, the borrower then can either save the input data and return to the list of loan programs or the automated loan placement system can calculate the transaction information and loan program details. The calculations made by the automated loan placement system at this stage determine whether the borrower pre-qualifies for the selected loan product. In one possible embodiment, if the borrower or user does not pre-qualify, the automated loan placement system searches the database for loan products for which the borrower or user does pre-qualify. In another possible embodiment, the automated loan placement system explains why the borrower or user did not pre-qualify for the selected loan product. If the borrower or user does pre-qualify for the loan product, the automated loan placement system can then generate a pre-qualification letter which the borrower can print or e-mail. The borrower can then take the printed or e-mailed pre-qualification letter to the bank and/or mortgage company which offers the loan product to continue the borrowing process.

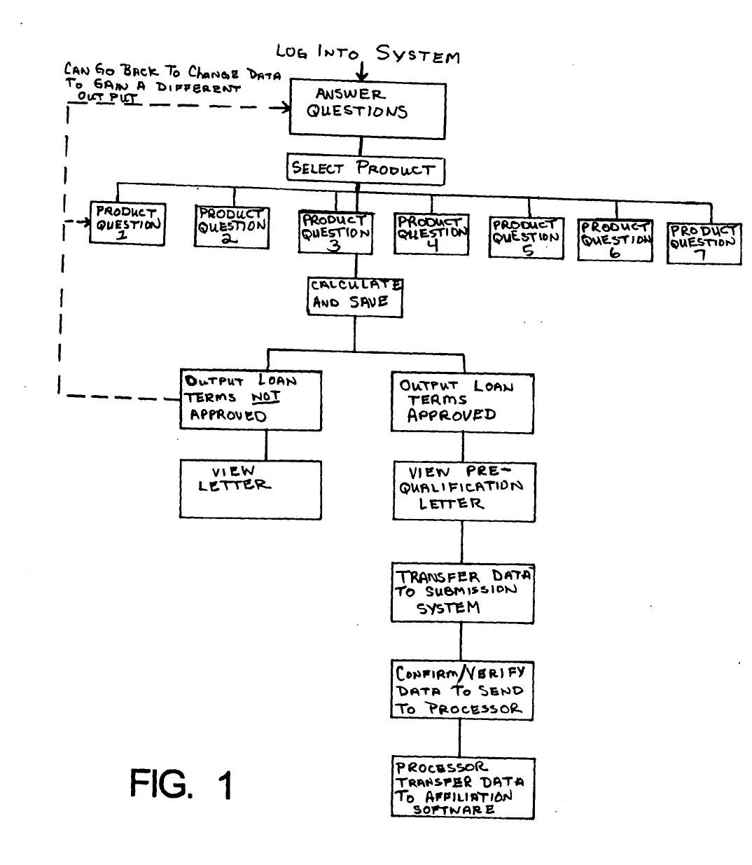

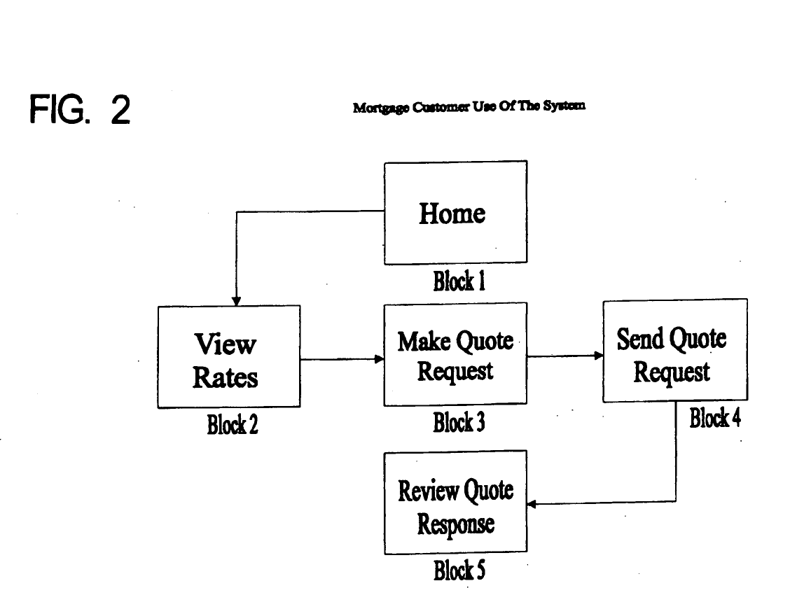

As an example of a patent application relating to mortgages, as described in published U.S. Application 2004/0199457 which is incorporated in its entirety herein, some details may be used as components of the present application. FIG. 1 of U.S. Application 2004/0199457, incorporated herein as FIG. 2 of the present application, describes how a mortgage customer uses the website embodiment to shop for a mortgage product. It is assumed that the customer has a fairly clear idea of: the type of mortgage product of interest, the amount of the loan, an estimate of the subject property value and an estimate of the customer's monthly income. Beginning at FIG. 2 Block 1, the customer has a variety of choices. The customer can proceed to Block 2 to get a quick overview of available rates, proceed to Block 3 to submit a quote request to a group of lenders selected by the customer, or proceed to Block 5 to review lender quote responses to previously submitted quote requests. The most likely of these choices is to first proceed to Block 2 and get an overview of rates for a given mortgage product.

Block 2 View Rates allows the customer to quickly define the minimum set of parameters for defining a mortgage product. This minimum set is selected by the customer and is comprised of: subject property state, number of units in the property, loan amount, loan type (conventional or VHA), and the product type (e.g. 30 year fixed rate, 15 year adjustable, etc.). Once selected, the system retrieves mortgage quotes from a database for a set of lenders whose parameter set matches the customer input. For each lender, four rates are displayed: the most recent actual rate registered by the lender along with the date/time that the rate was received, and three estimated rates. The three estimated rates are current rate estimates for the lender based on total points paid of 0, 1, and 2 points.

The concept of rate estimates is a core concept for the present application and will be explained by way of contrast with existing mortgage rate shopping systems. Most systems that allow customers to shop for mortgage rates rely on lenders who subscribe to those sites to update their rates on a regular, often daily basis. Rates presented at these sites are usually accurate to within one day since that is the frequency that most lenders will perform rate updates. The information model employed by these sites is one in which the lenders produce the rate data and the customer consumes the rate data. This model is also the major reason that many mortgage sites have relatively poor coverage of the total number of lenders who sell a particular mortgage product and are licensed in a particular state. There are simply too many lenders and the process is too laborious for any one site to represent more than a small number of available lenders.

In contrast, the invention uses an information model in which rate data sent by a lender to the customer for a specific customer quote request is stored both in a personal data area for the customer's use and in a system wide database for use by all customers. While the lender has the option to update rate information as often as desired, the main lender interface with the system is to answer specific quote requests from specific customers. To the lender, each quote request is essentially a sales lead and by responding the lender hopes to win the customer's business. In addition to storage in a personal data area for the customer's review, the system collects quote responses in a database along with a time tag for when the response was received. The intent is to allow customers to indirectly share the mortgage rates they receive via lender responses with all mortgage customers who use the system. When another customer requests current rate information for the same type product, these time tagged rates for past quote responses are translated into a current rate estimate for display to the new customer. For any given product type, a single lender quote response is enough for the system to continue to supply customers with current estimated rates indefinitely. Because a lender must only answer a single customer's request in order to be carried indefinitely by the system for review by all customers, the system's coverage of available mortgage lenders is extensive and grows quickly. The system is careful to explain to the customer, which rates are actual and which rates are estimates. While rate estimates tend to be quite accurate, the intent is that the system sacrifices some rate accuracy in the interests of greatly expanded coverage of available mortgage lenders.

In order to translate a rate received in the past into a current rate estimate, the system tracks 30 year fixed rate mortgage product data for a fixed number of randomly selected lenders. This is done independently of any customer quote request or lender quote response and is stored in a database on a daily basis. Its purpose is to provide the system with an index for use in calculating estimated rates.

The calculation of the system's rate index for a given day is done by taking: (1) The mean of lender products' rates sampled on the given day for a 30 year fixed rate mortgage at 0 points and (2) A rate approximation derived by applying a fourth degree least squares approximating polynomial solution to the means collected for the last ten days of index rate data. Finally, the maximum of the index value for (1) and (2) is taken as the given day's rate index value.

When a quote response with an actual rate is received for a customer, the system stores the rate, a time tag of when the response was received (T1), and a difference (D) between the response rate and the current system rate index (I). When the system needs to calculate an estimated rate for some later time (T2), it first selects the most recent actual rate for the selected product type for a given lender. The estimated rate (ER) at time T2 is then: ER=(I at T2)+D. That is, the estimated rate is equal to the system index rate at time T2 plus the rate difference D calculated above. This estimated rate is the system's best approximation to what a rate received in the past is equal to at the present time. The method is the system's means to allow customers receiving quote responses at different times to synchronize the rates they receive with other customers thereby allowing customers to share rate information.

Continuing at Block 2 (View Rates), the display of estimated rates at 0, 1, and 2 points is significant because there will typically be multiple lender rates displayed at the same time. Displaying the estimated rate at standard points amounts makes it easy for the customer to quickly compare lenders. The customer also has the option to enter any points amount of their choosing and the system will re-calculate all estimated rates for this new points amount. The estimated rate defined in is a rate estimate for zero points. The display of lenders rates in Block 2 is sorted from lowest rate to highest rate. Rate estimates for non-zero points amounts are calculated as follows: Rate at P points=(Rate at 0 points)+PointSlope*(Number of Points). The term ‘PointSlope’ is an estimation of how the lender's rate changes as a function of the number of points paid by the borrower. In order to calculate the PointSlope, the system considers two scenarios. (1) If the system has data for a given lender product based on at least two quote responses (R1 rate at P1 points and R2 rate at P2 points) then the PointSlope=(R2−R1 )/(P2−P1). (2) If the system has insufficient data to calculate the PointSlope, a PointSlopeAverage function is used instead to derive the PointSlope. The PointSlopeAverage function is derived by random sampling rate data from a large number of lenders for both 15 year and 30 year fixed rate products. The PointSlopeAverage function performs simple linear interpolation using rate and point data averages for the 15 and 30-year terms of the sample set. When a specific PointSlope is needed for a specific lender product, the product term is passed to the PointSlopeAverage function. The function returns an estimate of the industry average PointSlope for that product term.

Continuing at Block 3 (Make Quote Request), the customer decides that some of the rates presented in Block 2 (View Rates) are of interest and wishes to contact a set of lenders to inquire about mortgage rates specific to the customer's needs. The system asks the customer to enter a few pieces of additional data not obtained in Block 2: name and monthly income and gives the opportunity for the customer to ask a set of to be selected lenders a question pertinent to the customer's lending situation. Customer data transmittal over the Internet is protected via SSL encryption for any interaction that involves the customer name and monthly income. Once the quote request is defined, the system will then retrieve and display lender rates as defined by the customer's product interests in a manner similar to Block 2 (View Rates). The customer will then have the option to select one or more of the displayed lenders.

Upon selecting a set of lenders, the system proceeds to Block 4 (Send Quote Request). The customer may review the quote request to be sent as well as the set of lenders to which the request will be sent. Quote responses sent by the lenders are viewed by the customer in a personal data area set up by the system for each customer. To facilitate this, new users are asked to create a login profile and returning users are asked to log in prior to the system's sending the set of quote requests. After log in, the system sends the quote requests via email to the set of selected lenders. In addition, the system may send the requests to some additional lenders not selected by the customer. These additional lenders are selected at random from a list of all possible lenders that match the customer's quote request. An alternate and future method would be to select lenders using a weighted average scheme where the additional lender is selected based on 1) the lender is a preferred lender and 2) the system does not have current rate information for a lender and needs to update its rate data for that lender.

Continuing at Block 5 (Review Quote Response) implies the customer has returned to the website at some later time to review the lenders' responses to an earlier generated quote request(s). All responses are maintained in a data area that is personal for each customer. Customer data areas are kept secure using a userid and password login that is required prior to access to a customer's quote responses. Userid parameters that appear in the customer's web browser URL window are secured by using an encryption scheme, which insures that no customer can modify the userid to gain access to any other user's data area.

After customer login, lender responses in the form of 1) rate quotes matching the customer request, 2) responses to any customer questions contained in the request, and 3) lender contact information in the form of lender website links and lender contact phone numbers. At this point the customer's interaction with the system ends and the customer would pursue loan origination with a chosen lender by contacting the lender directly.

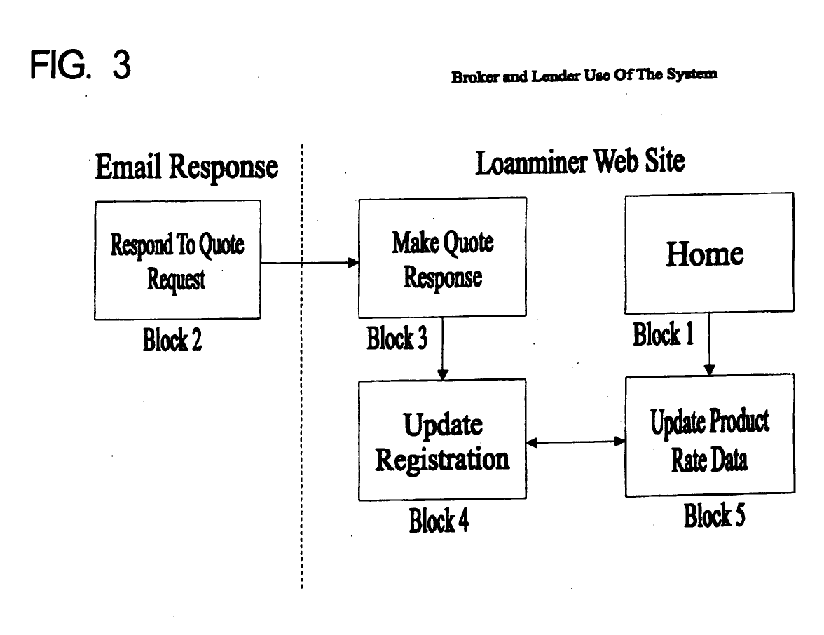

FIG. 2 of U.S. Application 2004/0199247, herein incorporated as FIG. 3 of the present application, describes lender interaction with the system. While most lenders who use the system have websites to represent their mortgage firms, the system can process any lender that has 1) an active domain name and 2) a valid email address. The system maintains two points of entry for the lender. One is the home page referenced in Block 1 (Home), which is simply accessed using the site URL, and the other is through direct response to a customer quote request, referenced in Block 2 (Respond To Email Request).

Beginning at Block 1 (Home), the lender may login to their previously initiated account in a manner similar to the user login. Login provides the system with a lenderid that is encrypted whenever it is carried as a browser URL window parameter to ensure that no lender can access any other lender's account. After logging in, a lender may proceed to any of the lender functions represented in Block 4 (Update Registration) or Block 5 (Update Product Data).

Block 2 (Respond To Quote Request) represents the action of a lender responding to a customer quote request issued. Following a link in the email will take the lender to Block 3 (Make Quote Response). To respond to a customer quote, the lender enters the product rate data requested by the customer and answers any customer question contained in the request. The system will then determine whether the lender is already registered with the system or is a new lender to the system. If the lender is new, the lender will be directed to register their mortgage firm via Block 4 (Update Registration) and enter product rate data via Block 5 (Update Product Rate Data).

Block 4 (Update Registration) provides the means for the lender to enter or update contact information for the lender's company. Such contact information such as lender address, lender URL, and lender email address allows the system to keep track of changes in the lender's physical or online contact data.

Block 5 (Update Product Rate Data) provides the means for the lender to update product rate data that is outside the scope of the response to an individual customer's quote request. Lenders may update as many product rates as they wish and may update product rate data as often as they want. If the lender has updated rate data on the day that a customer requests a matching product for this lender, the rate provided by the lender will be used. If the lender rate data is not current, then a rate estimate will be used to generate rate data displayed to the customer. This gives the lender the flexibility of updating rate data as often as desired but not necessarily on a consistent daily basis.

U.S. Patent Application 2004/0199458, which relates to a system and method for providing information about available mortgage loan programs to a consumer through an electronic communications network such as the Internet, may have components which can be used in the present application and is incorporated in its entirety herein. The system and method of the present invention provide the consumer with rates for which the consumer is qualified. In specific embodiments of the invention, the system and method of the invention further provide the consumer with information about the closing costs that would be incurred to close the loan, and provide the consumer with the opportunity to apply for the loan and be immediately approved.

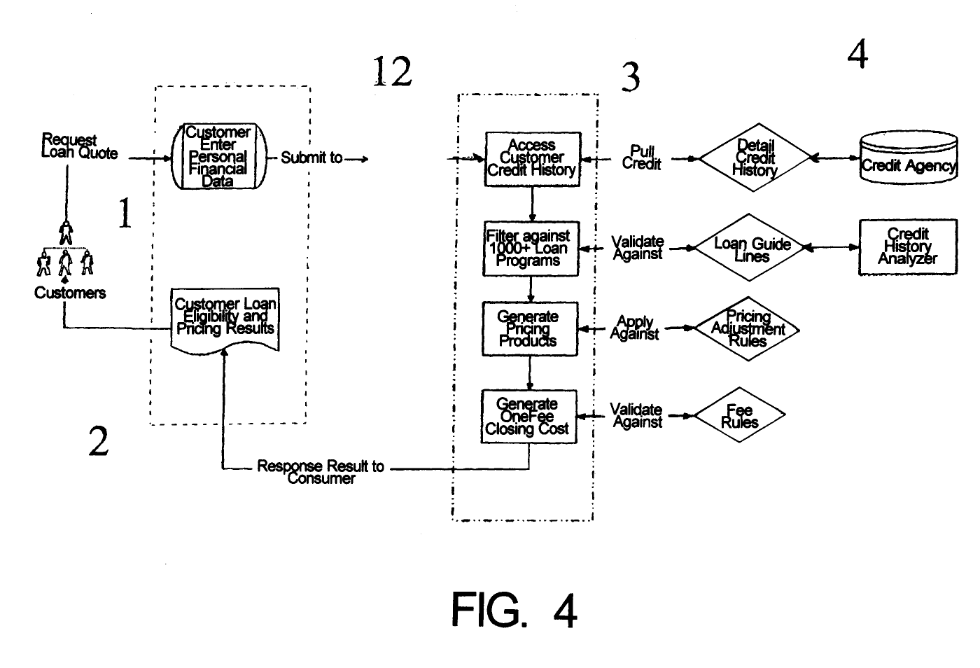

FIG. 1 of U.S. Application 2004/0199458, herein incorporated as FIG. 4, shows a diagrammatic representation of an embodiment of the system and method of the invention. In accordance with the invention, a consumer 1, or a user acting on behalf of the consumer, makes use of a first computer, indicated by dashed box 2. The first computer system is connected to a second computer, indicated by dashed box 3 via an electronic communications network such as the Internet. The mechanism by which the first and second computers make connection to the communication network need not be of any particular type and may include without limitation standard telephone modem connections, ISDN, ADSL or SDSL connection, cable modem connections, satellite connections, other wireless connections, and combinations thereof.

In the first step of the invention, the customer enters personal information into the first computer, for example through a web site interface. This personal information includes sufficient information about the consumer making the inquiry about available loan rates, and about the type of mortgage and mortgage loan program desired to permit the determination of the persons' credit worthiness and to present available mortgage loan programs of the type of interest. The entered information is transmitted via the electronic communication network (arrow 12) to the second computer 3. This second computer 3 is generally at a location remote from the first computer 2 and is in any event not accessible to general consumers.

In response to the received transmission from the consumer, the second computer develops a credit worthiness rating for the consumer. In a preferred embodiment, this process includes the step of accessing a detailed credit history for the consumer. This may be accomplished, for example, by querying a third computer 4 associated with a credit reporting agency, although the credit records could be maintained on the second computer without departing from the invention. The present invention provides a first mortgage origination system that allows the borrower, prior to submitting an application, to see accurate rates and fees on loan programs for which they actually qualify. The invention employs several criteria to adjust pricing or eliminate loan programs in accordance with a borrower's individual characteristics, including but not limited to loan to value ratio, low documentation versus full documentation of financial status, employment status, whether the mortgage sought is a “cash-out” mortgage, location of property, size of loan and occupancy status.

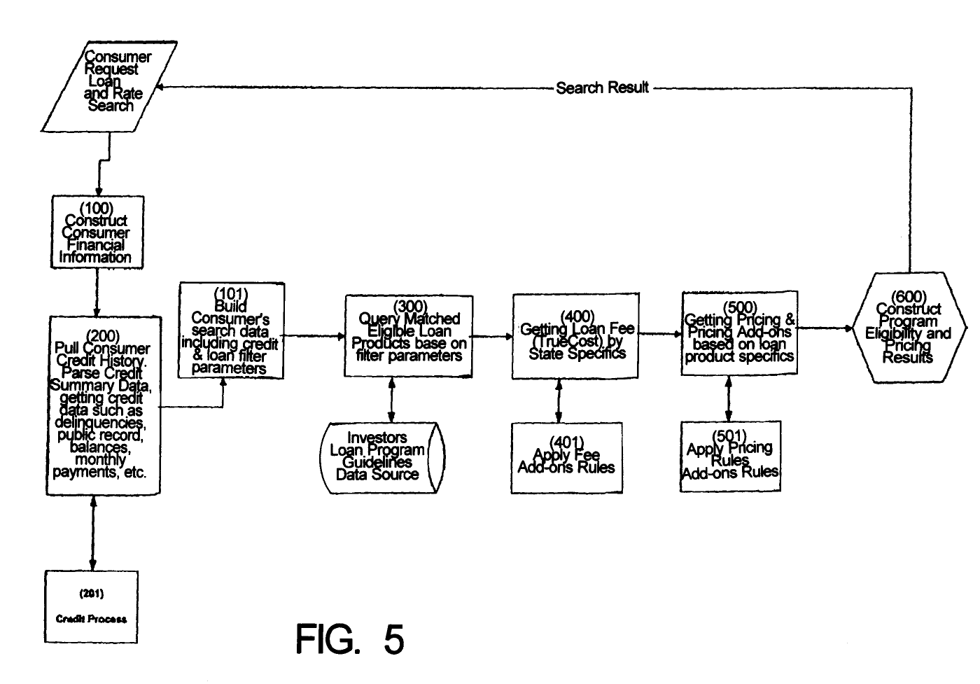

FIG. 2 of U.S. Application 2004/0199458, herein incorporated as FIG. 5, shows in greater detail a flow chart of the process done by the second computer 3 in an embodiment of the invention. Upon receiving a consumer request for loan eligibility and rate search, the process begins by constructing a summary of consumer financial information in a standardized format (100). This information is used as the basis for creating a more detailed consumer-specific report (200), including collection (201) of a credit report, generally from a third-party information source, for example one or more credit agencies.

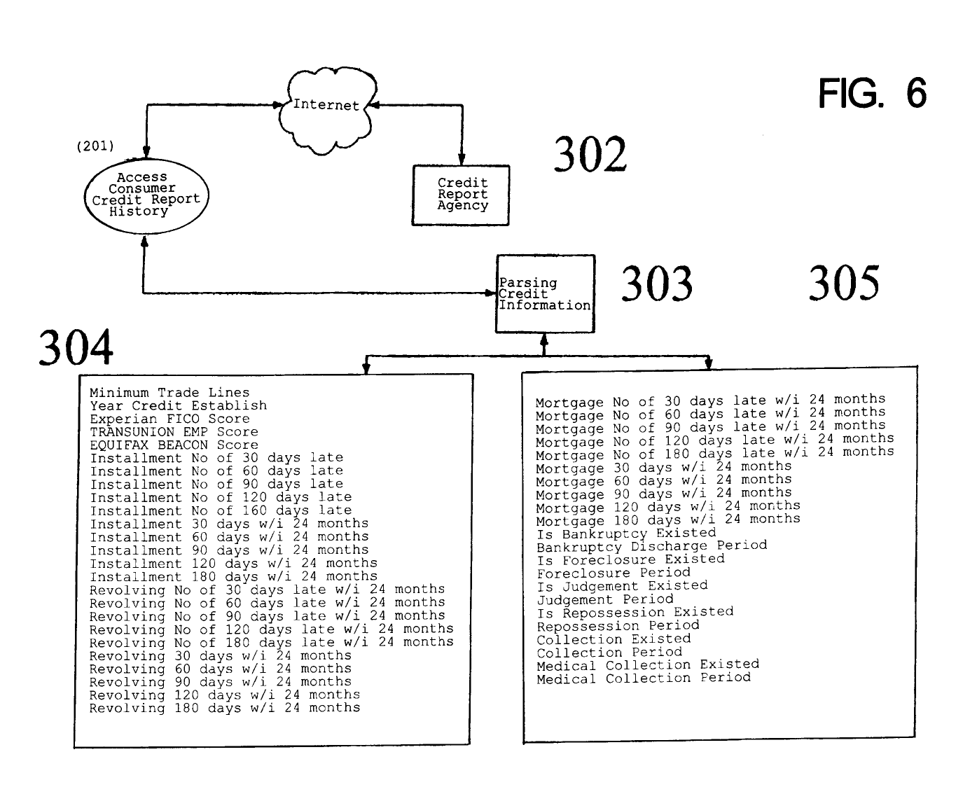

FIG. 3 of US application 2004/0199458, herein incorporated as FIG. 6, shows a detail view of the credit history report collection process (201). Process (201) requests, for example via the internet information from a remote information source such as a credit reporting agency (302). The information is returned and is parsed by the processor (303) into ordered lists of information. Exemplary lists (304) and (305) are shown in FIG. 6, although the specific order and the specific information may vary from one embodiment to another.

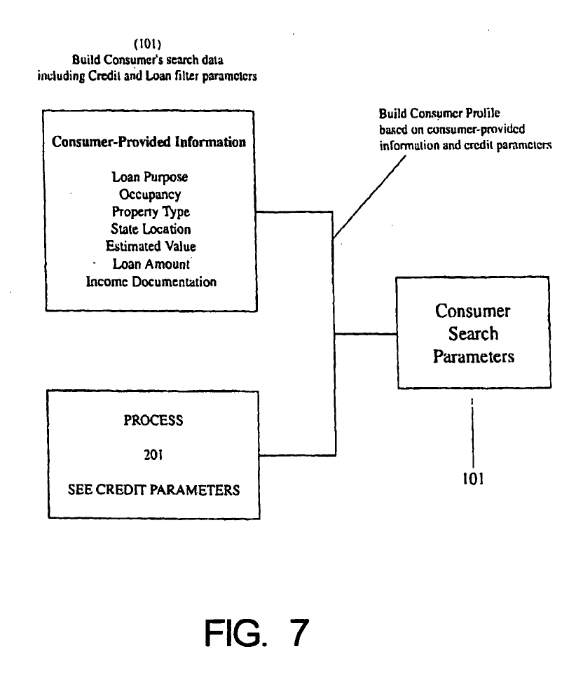

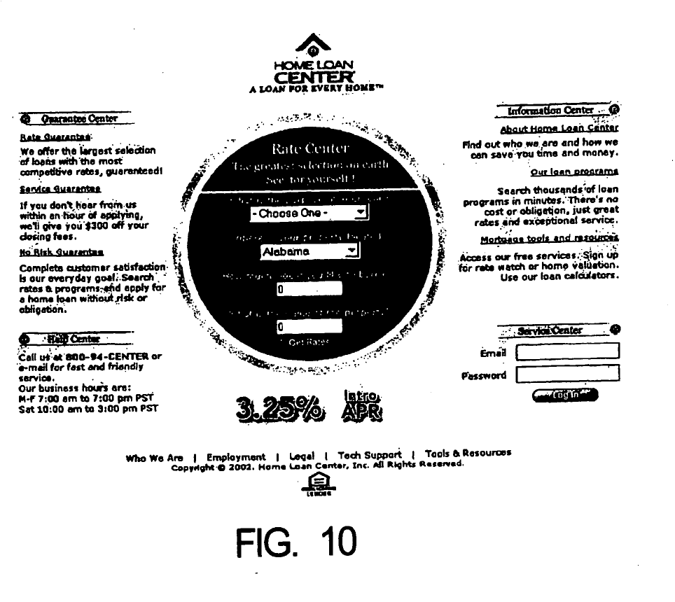

Looking again at FIG. 5, the collected information about the consumer's credit history and other information received from the consumer is used to build a set of consumer-specific search parameters (101). This process is shown in more detail in FIG. 7 of US application 2004/0199458, herein incorporated as FIG. 10. Basically, the consumer-specific loan parameters (40) are combined with the consumer-specific credit parameters obtained in step (201) to yield a set of consumer-specific search parameters.

Once the search parameters (101) are determined for the consumer's request, they are matched to eligible loan programs (FIG. 5, 300). This process involves an item-by-item comparison of the information in the search parameters with the information in an investor's loan program guidelines (301 in FIG. 5) to arrive at a final subset of mortgage loan programs selected from a database containing a plurality of mortgage loan program listings. Preferably, this database contains at least 100 distinct mortgage loan programs, more preferably at least 1000 distinct mortgage loan programs. These mortgage loan programs are distinguished based on the characteristics in the search parameters list.

Those programs for which the consumer does not qualify are eliminated, and the final subset of available mortgage loan programs is identified for which the applicant does qualify. In some cases, one loan program for which the applicant qualifies may completely dominate another, for example when all terms and conditions but one are equal, in which case only the better of the two programs may be included in the final subset of available mortgages loan programs.

The elimination process is generally performed in multiple iterative steps, comparing one search parameter at a time against the loan program guidelines to establish successive intermediate subsets of mortgage loan programs. While the order in which these iterative steps are performed is not critical, it is desirable to perform the steps in a manner which generally minimizes the number of iterative steps. This can be accomplished by selecting for the initial comparisons those parameters which are most likely to eliminate the greatest numbers of mortgage loan programs. One method for accomplishing this is by consideration of parameters in the same order for all consumers, with the order being selected to be consistent with the mortgage loan programs available in the database. For example, if all of the mortgage loan programs are substantially nationwide in availability, then the state location is a parameter of little discriminatory value, and it would be considered later. On the other hand, if the mortgage loan programs tended to be ones available in only limited geographical regions, then the state location might well be a parameter considered early because it could eliminate many unavailable programs. Alternatively, one can utilize a consumer-specific evaluation order by rating each search parameter (for example as easy, moderate, or difficult) and searching those parameters with difficult ratings first.

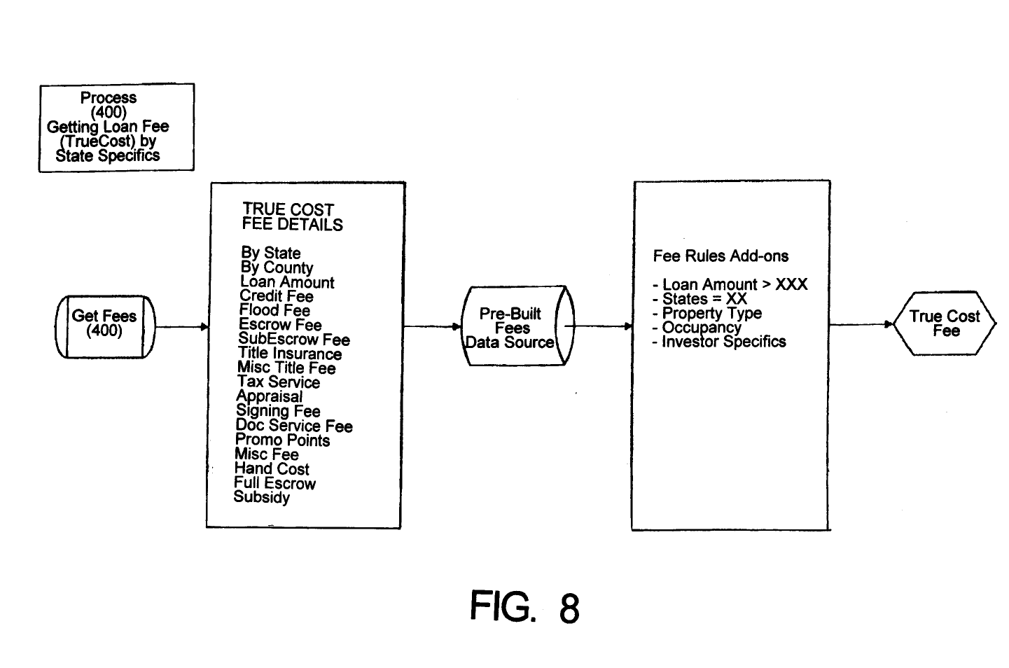

Once available loan programs are identified, the fees associated with each program can be determined for the specific consumer and transaction by application of defined fee and add-on rules (FIG. 5, 400, 401) to determine the actual cost of each loan program for the consumer. As reflected in FIG. 5 of the U.S. Application 2004/0199458, hearing incorporated as FIG. 8, the loan fee may depend on the geographical location of the property, planned occupancy, requirements for escrow fees and title insurance, appraisals and the like. The pre-built fees database contains all of the lender fees charged by the lender for the mortgage program, including minimum fixed costs of third parties to close a loan in order to produce an accurate fee for typical loans, for example a Fannie Mae loan. The pre-built fees data base may also contain additional fees that may apply to a typical loans, and which are determined by the consumer-specific information. In general, there are four factors that may cause a fee add-on for a loan: (1) a loan amount above a certain threshold, (2) a property location, since some states require that attorney perform the closing which can increase the cost of the closing; (3) an unusual property type, and (4) unusual occupancy.

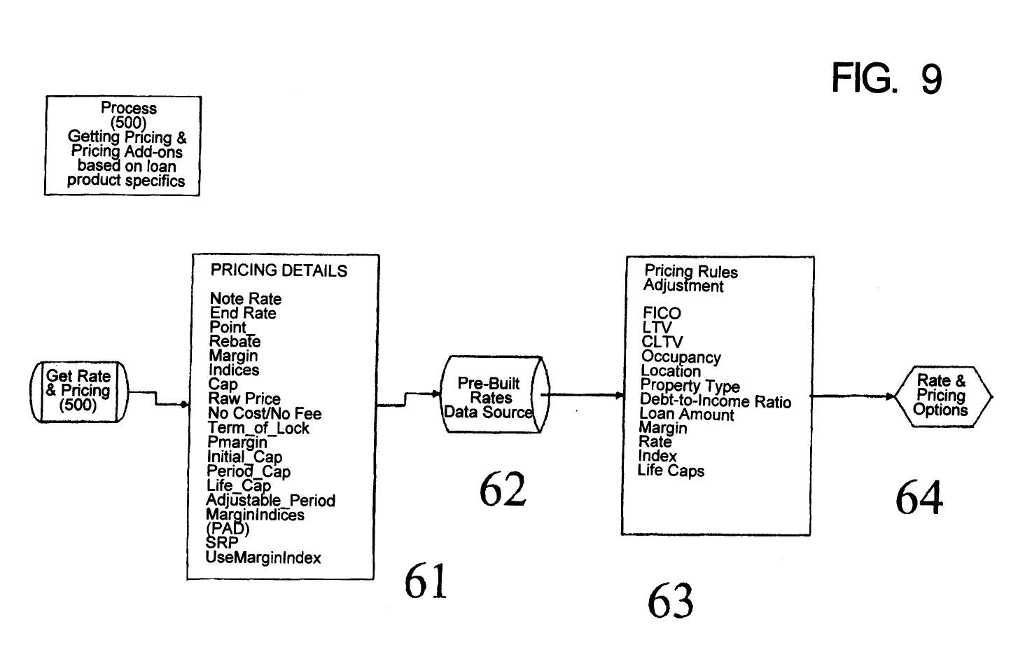

The final step (500) in FIG. 5 is the application of pricing adjustments. Pricing adjustments are optional, but will usually be done. Pricing adjustment may also be done prior to the determination of associated loan fees. The pricing adjustment program applies adjustments (up or down) from a base rate for such things as a high or low loan-to-value ratio or a jumbo or super-jumbo the amount to be financed. FIG. 6 of US Application 2004/0199458, herein incorporated as FIG. 9, notes pricing details 61 that may be adjusted through the application of a pre-built rate data source 62 in light of factors 63 to arrive at rate and pricing options 64 which are returned to the main program for application.

After selection of the subset of mortgage loan programs and any pricing adjustment that is required, the resulting information can be transmitted to the consumer at the first computer. In preferred embodiments of the invention, this transmission of the available mortgage loans is automatic and immediate. As used in the specification and claims of this application, the term “automatic” refers to processes that (in the absence of error or system failure) occur through the actions of computerized systems only, and without individual human intervention or analysis. The term “immediate” refers to processes which occur at speeds governed only by the involved computer processing and data transmission rates, and which are not delayed for human review or authorization. In general, subject to computer or system failure this means that a response will be received within minutes, for example within 20 minutes or less, preferably within 10 minutes or less and more preferably within 1 minute or less and opposed to the 24 hours period commonly quoted by businesses which purport to offer competitive mortgage bidding.

The subset of optionally-price-adjusted mortgage loan programs which is transmitted by the system and method of the invention provides the consumer with a real display of rates that are available to the particular to consumer, not an unrealistic advertising picture of teaser rates for which the consumer may not qualify. This allows the consumer to do meaningful comparison shopping between loan programs that are actually available to the consumer, and thus facilitates the selection of an appropriate mortgage loan program.

In a further embodiment of the invention, the information transmitted to the first computer for display also includes a statement of closing costs for the particular mortgage loan program. This statement of closing costs can be a “one-fee” program in which a flat stated fee is charged regardless of the actual expenses incurred in a particular closing, and regardless of the mortgage program selected. In other cases, the closing costs to be charged may depend on the mortgage loan program selected, in which case different closing cost amounts would be listed for each mortgage loan program in the selected subset.

In a further embodiment of the invention, when the closing costs are stated as part of the transmitted data as a guaranteed amount, the listing of the subset of mortgage loan programs constitutes an offer to the consumer to make a mortgage loan on the terms stated, subject only to the accuracy of the information provided by the consumer, including in particular, information about the nature and value of the property. In this embodiment of the invention, the consumer is given the opportunity to press a button to accept the loan as presented, and the loan application process is then complete. Loan paperwork based on the input information is then generated and sent to the consumer for signature, after which the loan is funded through the selected mortgage loan program.

Thus, in a first embodiment of the invention, there is provided a system for providing information about available mortgage loan programs to a consumer through an electronic communications network, comprising a first computer located at a first location accessible to the consumer; and a second computer system which is not directly accessible by the consumer, said first and second computer being connected to each other via the electronic communications network, wherein

(a) the second computer has access to a database of information of containing credit reports on consumers who may use the system;

(b) the second computer is programmed to direct the first computer to display a data collection display into which the consumer or other user acting on behalf of the consumer enters personal identification and financial information about the consumer;

(c) the second computer is programmed to receive information transmitted by the first computer from the data collection display and to obtain a credit report for the consumer;

(d) the second computer is programmed to process the credit report and any additional financial information received from the consumer to arrive at a credit worthiness value;

(e) the second computer has access to a database containing a listing of a plurality of mortgage loan programs, and is programmed to filter this database based on the credit worthiness value to generate a subset of mortgage loan programs for which the consumer qualifies; and

(f) the second computer is programmed to transmit a display of the subset of mortgage loan programs to the first computer, and

wherein all of the programmed actions of the second computer occur automatically in response to receipt of a transmission of a complete set of information from the first computer.

The invention further provides a method for providing information about available mortgage loan programs to a consumer through an electronic communications network, comprising the steps of

transmitting instructions from a second computer to a first computer located at a first location accessible to the consumer, wherein said instructions result in display of a data collection display into which the user enters personal identification and financial information about a consumer;

receiving via an electronic communication network at the second computer the personal identification and financial information of the consumer entered in the display using the first computer;

obtaining at the second computer a credit report for the consumer using the first computer;

processing in the second computer the credit report and any additional financial information received from the consumer to arrive at a credit worthiness value;

filtering a database containing a listing of a plurality of mortgage loan programs based on the credit worthiness value to generate a subset of mortgage loan programs for which the consumer qualifies; and

transmitting a display of the subset of mortgage loan programs to the first computer,

wherein all of the programmed actions of the second computer occur automatically in response to receipt of a transmission of a complete set of information from the first computer. The user and the consumer may be the same individual, or different individuals.

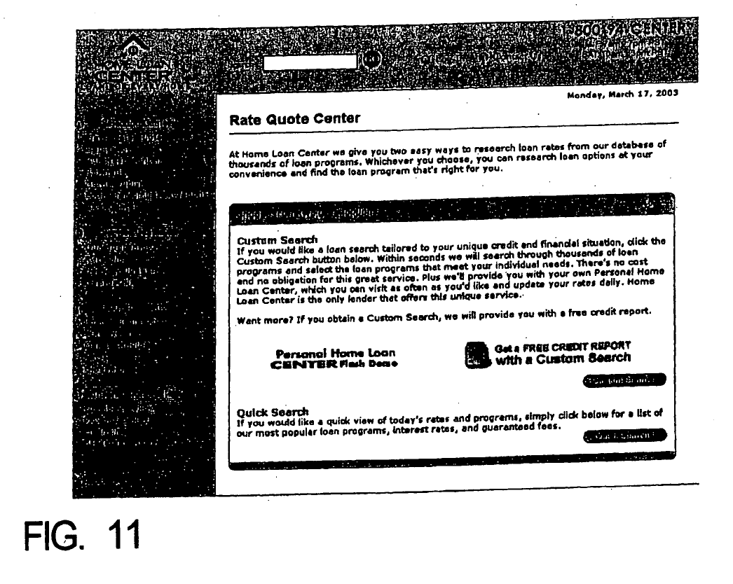

FIGS. 7 through 21 of US Application 2004/0199458, herein incorporated as FIGS. 10 through 24 respectively, show various pages of a web-based data and information collection system which may be used in the method of the present invention. These pages are provided to illustrate one embodiment of the invention and by no means represent the only manner in which the method of the invention can be implemented. FIG. 10 shows the opening page of the system. As shown, the page has input locations for the purpose of the loan (i.e, purchase, refinance, refinance-cash out) (71), the state in which the property is located (72), the amount to be borrowed (73) and the value of the property (74). The page also contains a log in area (75) for use by returning customers/users. The page also includes links to non-consumer-specific information about available loan programs, the service provider and the like. Once the user inputs the information requested on this page, the next page (FIG. 11) shows a screen in which a choice is offered between a conventional quick search and a custom search in accordance with the invention.

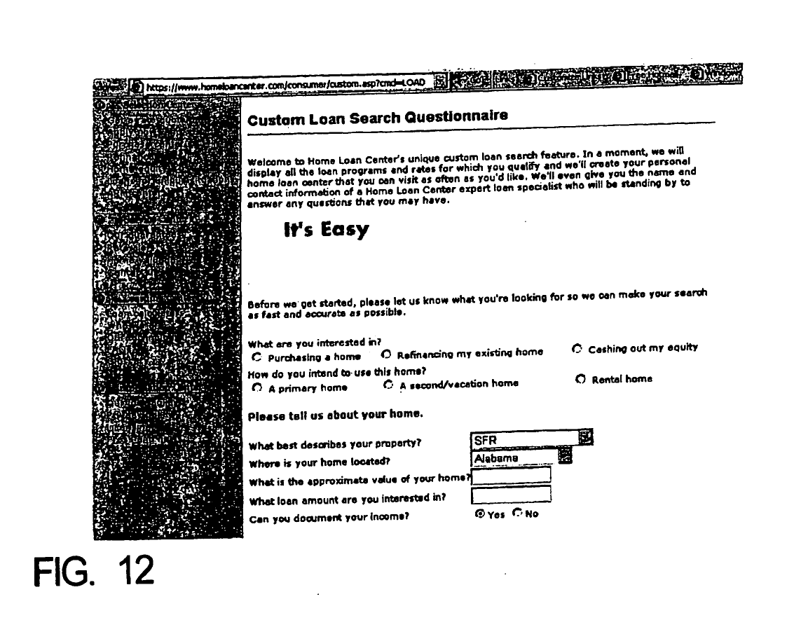

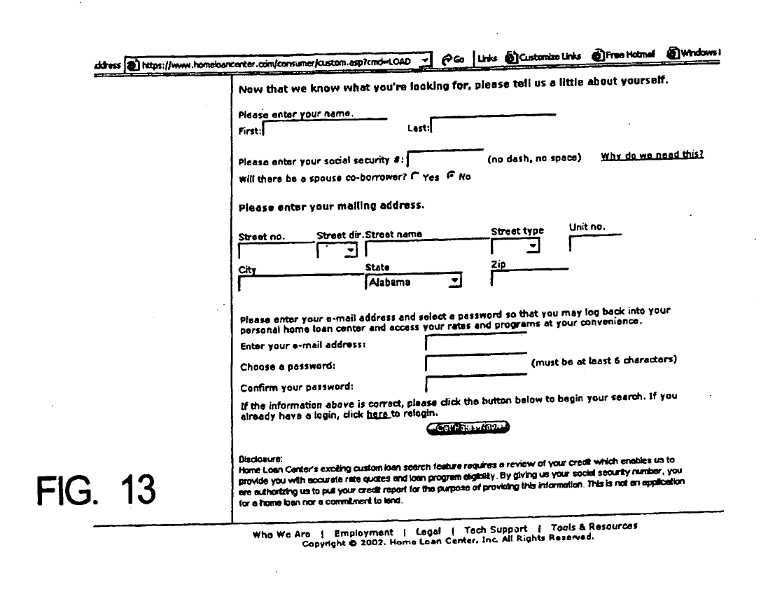

If the user selects the customer search, then FIGS. 12 and 13 show the next two pages of the web system in which basic customer information is collected (note that any information already provided by the user on a prior page will be auto-populated onto these pages). FIG. 13 also has entry fields for the creation of a user ID for immediate log in on subsequent visits.

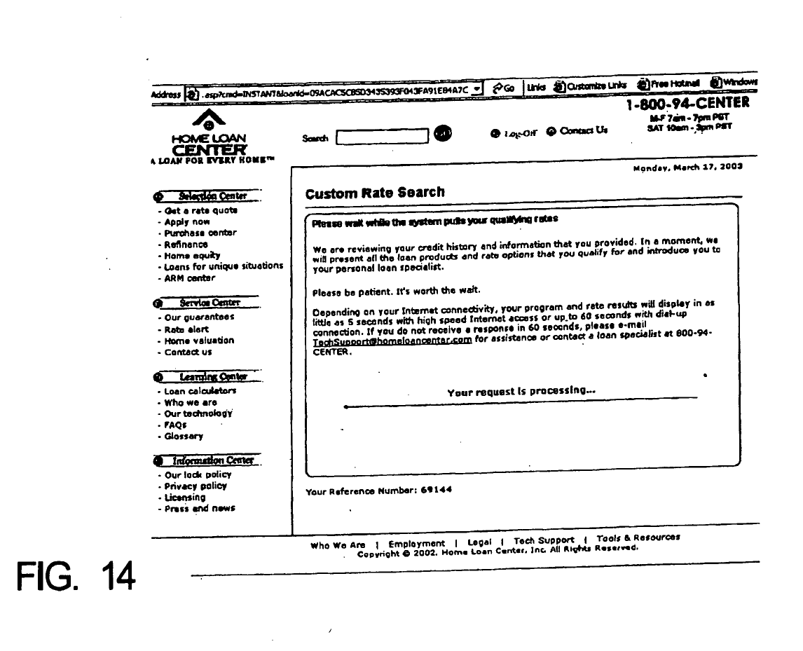

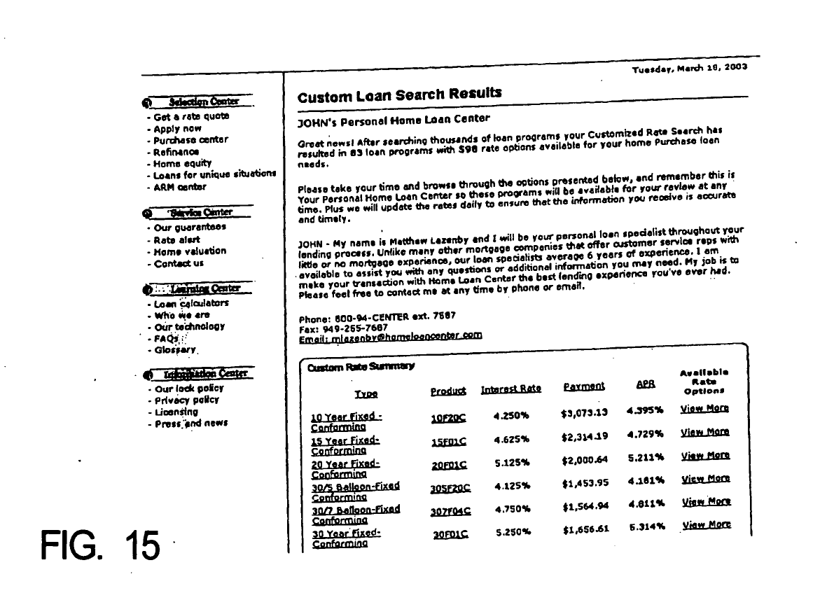

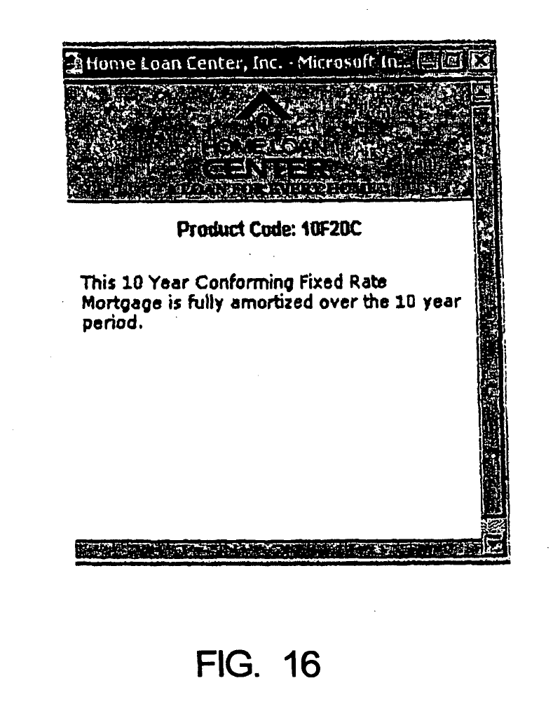

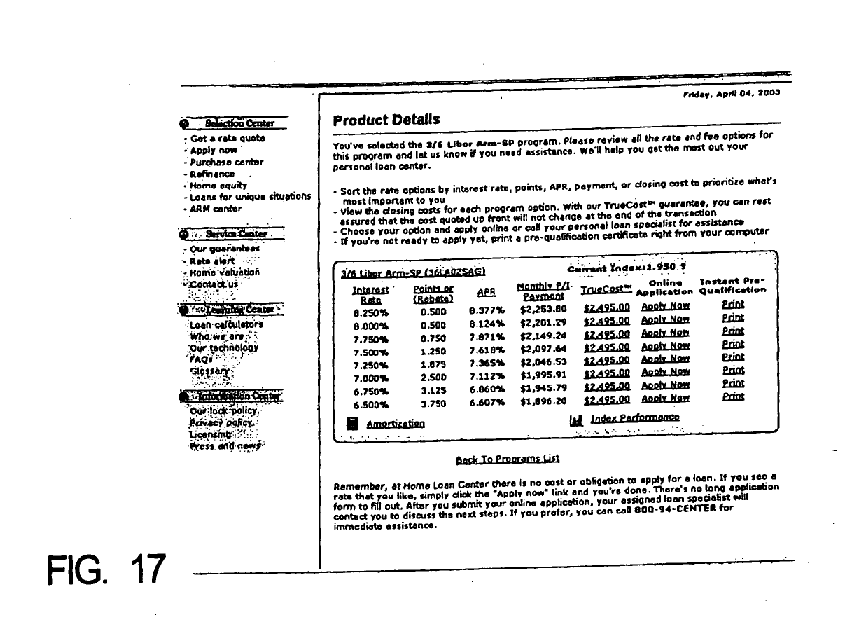

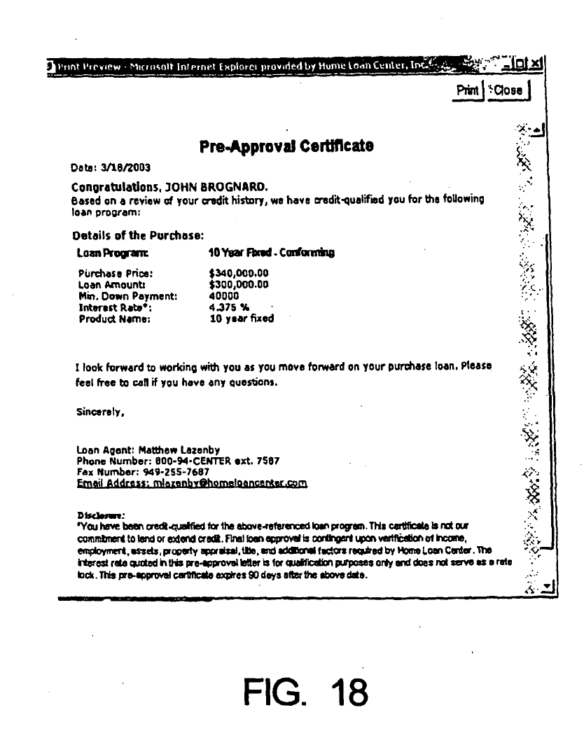

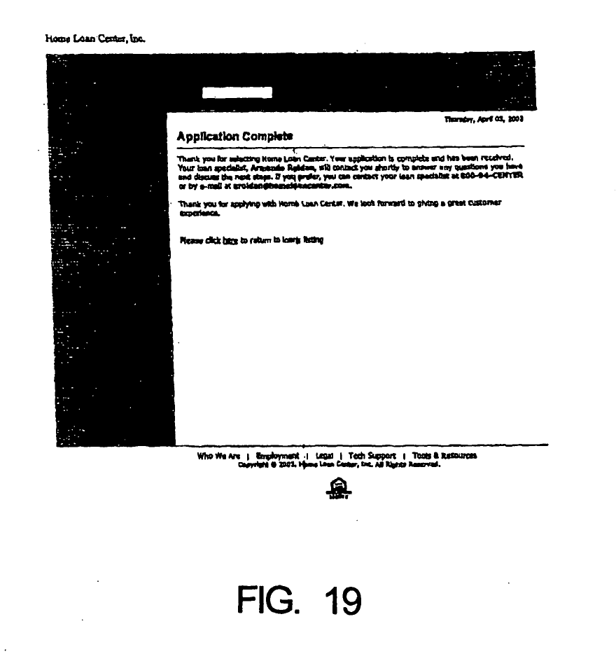

Once the user inputs the information requested on the pages shown in FIGS. 12 and 13 and indicates that he or she wants to proceed with the custom rate search, then the screen of FIG. 14 is displayed, showing that the evaluation is in progress. Within a very short time, generally in less than 60 seconds, a list of available loan programs is displayed, as shown in FIG. 15. In preferred embodiments, this display of available loan programs can be resorted into order by type, interest rate, APR, or payment by clicking on the corresponding column. Clicking the link in FIG. 15 in the “Type” or “Product” column displays a screen such as that shown in FIG. 16, which provides an explanation of the particular loan product to the consumer. Clicking the “View More” link in FIG. 15 in the “Available Rate Options” column displays a screen such as that shown in FIG. 17, which provides rate and point options within the loan program, and provides an option to “apply now” and an option to print a pre-approval certificate such as that shown in FIG. 18. If the consumer selects “apply now” on the screen shown in FIG. 17, then a screen such as that shown in FIG. 19 is displayed confirming that the user's application is complete and providing contact information regarding the loan specialist assigned to the application.

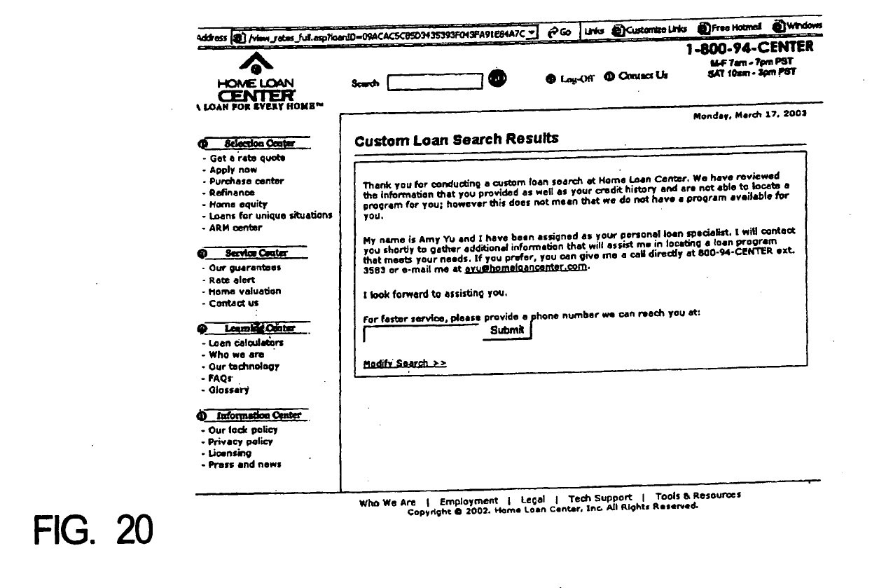

If the user inputs the information requests on the pages shown in FIGS. 12 and 13 and no loan programs are available based on such information, then FIG. 20 shows an example of the response provided to the consumer.

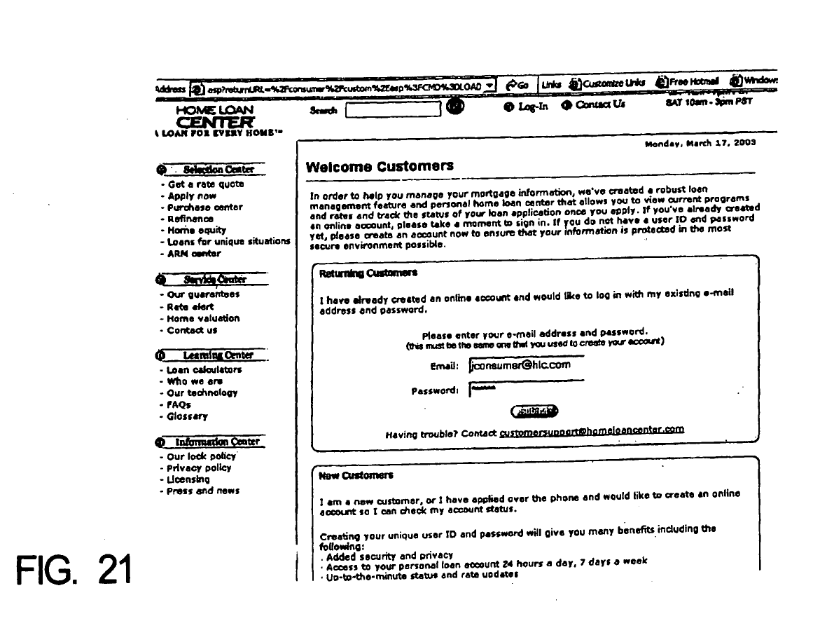

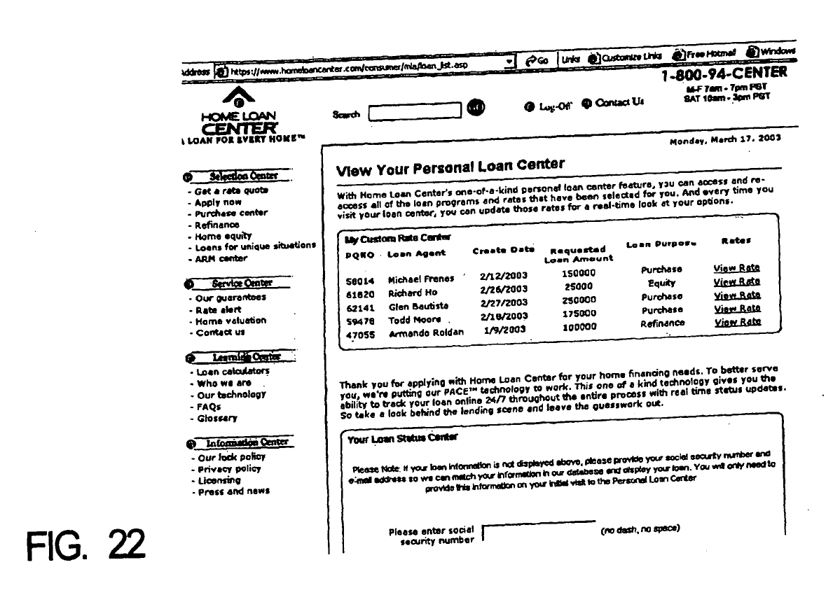

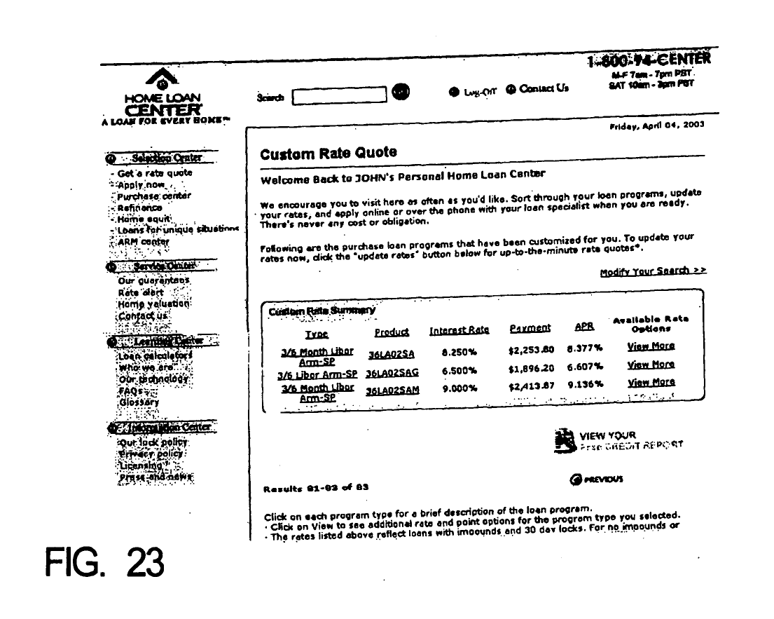

FIG. 21 shows an example of the page displayed to the user that has already conducted a custom rate search in a previous session and has returned to the website and accessed the log on feature shown in FIG. 10 (note that the log on feature is available from every page of the website). Once the consumer enters their log on information, the next page displayed is shown in FIG. 22. FIG. 22 displays all of the custom rate searches performed by the consumer. Clicking the link in FIG. 22 in the “Rates” column displays a screen such as that shown in FIG. 23. The screen in FIG. 23 is similar to the screen displayed to the consumer when they first performed the custom rate search (see FIG. 15). However, there is one additional function-a button that invites the user to “Update Rates.” If the user selects this option, then the system performs a new custom rate search and alters the data shown in FIG. 23 to reflect the programs available to the consumer at that moment.

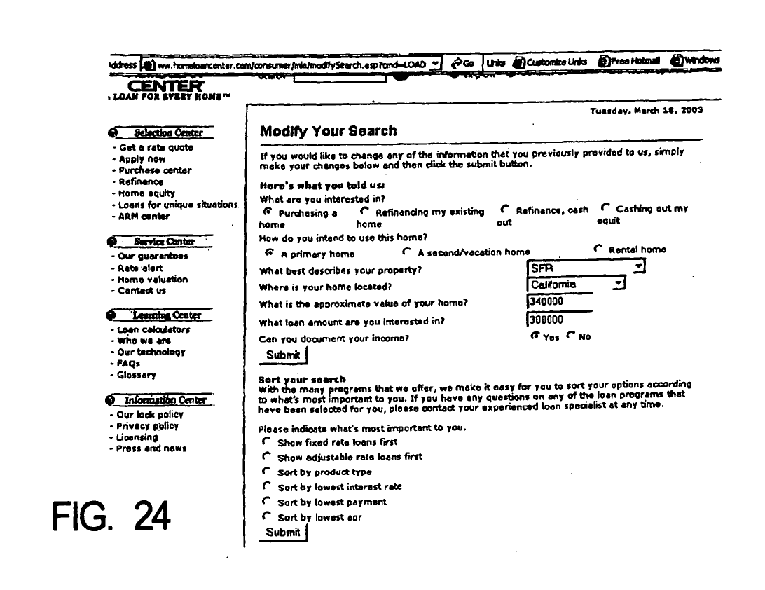

One final option available to the consumer (on the screens shown in FIG. 15 and FIG. 23) is a link allowing the consumer to modify his or her search parameters. Clicking the link titled “Modify your search” displays a screen such as that shown in FIG. 24, which allows the user to modify the information used by the system in performing the custom rate search.

The present application has been described in detail with reference to one embodiment. It shall be understood that these illustrations are by way of example and not meant to limit the present application.

One feature or aspect of an embodiment is believed at the time if the filing of this patent application to possibly reside broadly in a method of utilizing an automated loan placement system, wherein as the customer information is being entered, non-qualifying loan programs are being excluded. What remains are the loan programs that the customer can qualify for.

Marketing—allows businesses that need lending services as part of their job and to have it available on their desk top. Loan origination—allows the loan originator to provide instant information on qualification and terms for the borrower to make a quick decision. Operations—it streamlines the process of information. The data is inputted one time and then automatically sent to different departments.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

Some examples of patents and patent applications relating to mortgages which may possibly be used as components of the present application may possibly be found in the following US patents and patent applications: U.S. Pat. No. 7,089,503, having the title “MORTGAGE LOAN CUSTOMIZATION SYSTEM AND PROCESS,” published on Aug. 8, 2006; U.S. Pat. No. 6,985,886, having the title “METHOD AND APPARATUS FOR A MORTGAGE LOAN MANAGEMENT SYSTEM,” published on Jan. 10, 2006; U.S. Pat. No. 6,904,414, having the title “SYSTEM AND METHOD FOR IMPLEMENTING A MORTGAGE PLAN,” published on Jun. 7, 2005; U.S. Pat. No. 7,379,912, having the title “SYSTEM AND METHOD FOR PROCESSING LOAN INFORMATION,” published on May 27, 2008; U.S. Pat. No. 7,337,136, having the title “METHOD FOR STRUCTURING, PRICING AND SETTING A CURRENT MORTGAGE PRICE INDICATOR CONTRACT,” published on Feb. 26, 2008; No. 2008/0103964, having the title “MORTGAGE LOAN AND FINANCIAL SERVICES DATA PROCESSING SYSTEM,” published on May 1, 2008; U.S. Pat. No. 7,366,694, having the title “CREDIT/FINANCING PROCESS,” published on Apr. 29, 2008; No. 2007/0094127, having the title “MORTGAGE MANAGEMENT SYSTEM AND METHOD,” published on Apr. 26, 2007; No. 2008/0005015, having the title “SYSTEM AND METHOD FOR AGGREGATING MORTGAGE AND SALES DATA FOR GENERATING, ASSESSING AND QUALIFYING MORTGAGE LEADS,” published on Jan. 3, 2008; No. 2007/0067234, having the title “MORTGAGE LOAN SYSTEM AND METHOD,” published on Mar. 22, 2007; U.S. Pat. No. 5,940,813, having the title “PROCESS FACILITY MANAGEMENT MATRIX AND SYSTEM AND METHOD FOR PERFORMING BATCH, PROCESSING IN AN ON-LINE ENVIRONMENT,” published on Aug. 17, 1999; No. 2007/0094125, having the title “MORTGAGE MANAGEMENT SYSTEM AND METHOD,” published on Apr. 26, 2007; No. 2007/0055603, having the title “METHOD AND SYSTEM FOR DETERMINING WHICH MORTGAGE CHOICE IS BEST FOR A CONSUMER,” published on Mar. 8, 2007; U.S. Pat. No. 7,340,435, having the title “MORTGAGE LOAN DATA PROCESSING SYSTEM AND METHOD FOR A LOAN BROKER,” published on Mar. 4, 2008; U.S. Pat. No. 7,386,504, having the title “MORTGAGE LOAN DATA COLLECTION METHOD AND APPARATUS FOR A FINANCIAL PLANNING ORIGINATOR AND/OR FINANCIAL INSTITUTION ORIGINATOR OF A MORTGAGE LOAN,” published on Jun. 10, 2008; U.S. Pat. No. 7,315,841, having the title “MORTGAGE LOAN AND FINANCIAL SERVICES DATA PROCESSING SYSTEM,” published on Jan. 1, 2008; U.S. Pat. No. 6,904,412, having the title “METHOD AND APPARATUS FOR A MORTGAGE LOAN ORIGINATOR COMPLIANCE ENGINE,” published on Jun. 7, 2005; and U.S. Pat. No. 4,876,648, having the title “SYSTEM AND METHOD FOR IMPLEMENTING AND ADMINISTERING A MORTGAGE PLAN,” published on Oct. 24, 1989.

The purpose of incorporating U.S. patents, Foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

What is claimed:

1. A computer-implemented method of providing a borrower with information regarding pre-qualification of a mortgage loan, which method comprises the steps of:
logging into an Internet-based computer system which Internet-based computer system provides information regarding pre-qualification of a mortgage loan;
inputting a first series of data into said Internet-based computer system to allow said Internet-based computer system to generate a list of loan programs for which said borrower may qualify;
said step of inputting a first series of data comprises:
inputting said borrower's middle credit score;
inputting a co-borrower's middle credit score if applicable;
inputting program family;
inputting document type;
inputting purpose of loan;
inputting information relating to occupancy of the building to be mortgaged;
inputting property type;
inputting state where property is located; and
inputting if all borrowers will be occupying the property;
obtaining from said Internet-based computer system a list of loan programs for which said borrower may qualify;
selecting a loan product from a list of loan products generated by said Internet-based computer system based on the inputted first series of data;
inputting a second series of data into said Internet-based computer system to determine if said borrower pre-qualifies for said selected loan program;
said step of inputting a second series of data comprises:
inputting said borrower's name;
inputting said borrower's home telephone number;
inputting said borrower's work telephone number;
inputting said borrower's mobile telephone number;
inputting said borrower's e-mail address;
inputting said borrower's current address;
inputting how long said borrower has lived at said borrower's current address;
inputting type of ownership of said borrower at said borrower's current address;
inputting said co-borrower's name if applicable;
inputting said co-borrower's home telephone number if applicable;
inputting said co-borrower's work telephone number if applicable;
inputting said co-borrower's mobile telephone number if applicable;
inputting said co-borrower's e-mail address if applicable;
inputting said co-borrower's current address if applicable;
inputting how long said co-borrower has lived at said co-borrower's current address if applicable;
inputting type of ownership of said co-borrower at said co-borrower's current address if applicable;
inputting said borrower's employment type;
inputting said borrower's self-employment history;
inputting said borrower's salaried employment history;
inputting name of said borrower's current employer;
inputting said borrower's position with said borrower's current employer;
inputting said borrower's amount of years with said borrower's current employer;
inputting said borrower's years in said borrower's position;
inputting said borrower's gross monthly income;
inputting said co-borrower's employment type if applicable;
inputting said co-borrower's self-employment history if applicable;
inputting said co-borrower's salaried employment history if applicable;
inputting name of said co-borrower's current employer if applicable;
inputting said co-borrower's position with said co-borrower's current employer if applicable;
inputting said co-borrower's amount of years with said co-borrower's current employer if applicable;
inputting said co-borrower's years in said co-borrower's position if applicable;
inputting said co-borrower's gross monthly income if applicable;
inputting said borrower's liquid assets;
inputting said co-borrower's liquid assets if applicable;
inputting said borrower's current monthly housing expenses;
inputting said co-borrower's current monthly housing expenses if applicable;
inputting said borrower's mortgage/rent history;
inputting said co-borrower's mortgage/rent history if applicable;
inputting said borrower's number of years of credit history;
inputting said co-borrower's number of years of credit history if applicable;
inputting number of open trade lines reporting for;
inputting if all Judgments, Collections and Charge Offs over $5000 aggregate have been paid;
inputting bankruptcy filing date if applicable;
inputting bankruptcy discharge date if applicable;
inputting foreclosure completed date if applicable;
inputting said borrower's total monthly consumer debt payments excluding all housing payments;
inputting said co-borrower's total monthly consumer debt payments excluding all housing payments if applicable;
inputting said borrower's citizenship status;
inputting said co-borrower's citizenship status if applicable;
inputting name total number of current mortgages, residential and commercial;
inputting total number of current residential mortgages on 1-4 unit properties;
inputting if the subject property is the same as said borrower's current address;
inputting said subject property address;
inputting said subject property zoning;
inputting how long said borrower has owned said subject property;
inputting when said subject property was last listed for sale;
inputting monthly condo fees;
inputting annual property taxes and insurance premiums;
inputting loan program;
inputting goal;
inputting fair market value;
inputting cash out;
inputting if said borrower wishes to include taxes and insurance in the monthly payment;
inputting first mortgage balance;
inputting second mortgage balance;
inputting first installment loan balance;
inputting said second installment loan balance;
inputting first revolving credit balance;
inputting second revolving credit balance;
inputting other loan balance;
inputting shortage from new first;
inputting existing total mortgage payment;
inputting existing mortgage payment to principal;
inputting existing mortgage payment to interest;
inputting length of time said borrower has had said existing mortgage;
inputting expected mortgage duration;
inputting estimated closing date;
inputting type of closing costs preferred; and
inputting prepayment penalty option;
pressing a calculate and save button;
viewing a pre-qualification letter generated by said Internet-based computer system upon said borrower pre-qualifying for said selected loan program;
viewing a pre-qualification letter generated by said Internet-based computer system upon said borrower pre-qualifying for a loan program other than said selected loan program; and
viewing an explanation of why said borrower did not pre-qualify for said selected loan product upon said borrower not qualifying for said selected loan product.

2. A computer-implemented method of providing a borrower with information regarding pre-qualification of a mortgage loan, which method comprises the steps of:
logging into an Internet-based computer system which Internet-based computer system provides information regarding pre-qualification of a mortgage loan;
inputting a first series of data into said Internet-based computer system to allow said Internet-based computer system to generate a list of loan programs for which said borrower may qualify;
obtaining from said Internet-based computer system a list of loan programs for which said borrower may qualify;
selecting a loan product from a list of loan products generated by said Internet-based computer system based on the inputted first series of data;
inputting a second series of data into said Internet-based computer system to determine if said borrower pre-qualifies for said selected loan program;
pressing a calculate and save button;
viewing a pre-qualification letter generated by said Internet-based computer system upon said borrower pre-qualifying for said selected loan program;
viewing a pre-qualification letter generated by said Internet-based computer system upon said borrower pre-qualifying for a loan program other than said selected loan program; and
viewing an explanation of why said borrower did not pre-qualify for said selected loan product upon said borrower not qualifying for said selected loan product.

3. A computer-implemented method of providing a borrower with information regarding pre-qualification of a loan, which method comprises the steps of:
logging into an Internet-based computer system which Internet-based computer system provides information regarding pre-qualification of a loan;
inputting a first series of data into said Internet-based computer system to allow said Internet-based computer system to generate a list of loan programs for which said borrower may qualify;
obtaining from said Internet-based computer system a list of loan programs for which said borrower may qualify;
selecting a loan product from a list of loan products generated by said Internet-based computer system based on the inputted first series of data;
inputting a second series of data into said Internet-based computer system to determine if said borrower pre-qualifies for said selected loan program;
pressing a calculate and save button;
viewing a pre-qualification letter generated by said Internet-based computer system upon said borrower pre-qualifying for said selected loan program;
viewing a pre-qualification letter generated by said Internet-based computer system upon said borrower pre-qualifying for a loan program other than said selected loan program; and
viewing an explanation of why said borrower did not pre-qualify for said selected loan product upon said borrower not qualifying for said selected loan product.
